(19) United States
(12) Patent Application Publication
(10) Pub. No.: US 2026/0069097 A1
(43) Pub. Date: Mar. 12, 2026

(54) CLEAN BRUSH HEAD AND WIRELESS CLEANING EQUIPMENT

(71) Applicant: FAIRWAY ELECTRONIC CO., LTD., New Taipei City (TW)

(72) Inventors: Lin-Han Yen, New Taipei City (TW); Yu Jen Fang, New Taipei City (TW)

(73) Assignee: FAIRWAY ELECTRONIC CO., LTD., New Taipei City (TW)

(21) Appl. No.: 18/829,306

(22) Filed: Sep. 10, 2024

(51) Int. Cl. A47L 9/04

(52) U.S. Cl. CPC A47L 9/0472; A47L 9/0411

(57) ABSTRACT

A cleaning brush head includes a rotating disk, a plurality of suction disks and a plurality of brush disks. The rotating disk has a joint and a plurality of water inlets. The joint is located in the center of the rotating disk, and the plurality of water inlets surround the joint. A plurality of suction disks are disposed on a top surface of the rotating disk, and each suction disk has a water outlet channel. A plurality of brush disks are disposed on a bottom surface of the rotating disk opposite to the top surface and are spaced apart from the joint. The plurality of water outlet channels of the suction disks are communicated with the plurality of water inlets, and the plurality of water outlet channels are extended in a direction away from the joint.

### BACKGROUND

### Technical Field

The invention relates to a cleaning tool, and in particular to a cleaning brush head and a wireless cleaning equipment.

### Description of Related Art

The hull of a ship below the water surface is prone to adhere to dirt, seaweed or shellfish, so it needs to be cleaned regularly. The existing cleaning equipment needs to be connected with a cable to a power source on the ship or on the shore, and then allow divers to sneak in the water to operate the cleaning equipment for cleaning exterior walls of the ship, so the cleaning procedure is more complicated.

To this end, the present invention develops a wireless cleaning equipment. When the ship is floating on the water, divers can directly carry the wireless cleaning equipment and dive into the water to clean the surface of the ship hull, which can greatly simplify the cleaning procedure.

### SUMMARY

The invention provides a cleaning brush head that can guide the water flow during the cleaning process to avoid affecting the sight of user.

The clean brush head of the invention includes a rotating disk, a plurality of suction disks, and a plurality of brush disks. The rotating disk has a joint and a plurality of water inlets, the joint is located in the center of the rotating disk, and the plurality of water inlets surround the joint. The plurality of suction disks are disposed on a top surface of the rotating disk and each of the suction disks has a water outlet channel. The plurality of brush disks are disposed on a bottom surface of the rotating disk relative to the top surface and spaced apart from the joint. The water outlet channels of the suction disks are communicated with the water inlets, and the water outlet channels are extended in a direction away from the joint.

In an embodiment of the invention, the rotating disk has a main body, an outer ring and a plurality of blades, the outer ring is connected to an outer edge of the main body, and the plurality of blades are distributed between the main body and the outer ring to form the water inlets.

In an embodiment of the invention, each of the suction disks has a bottom plate and an upper cover, the bottom plate is fixed on the main body and the outer ring, and the bottom plate is communicated with the water inlets, the upper cover is disposed on the bottom plate and is extended along a radial direction to form the water outlet channel.

In an embodiment of the invention, further comprising a plurality of screws, passed through each of the bottom plates and screwed to the main body and the outer ring.

In an embodiment of the invention, the rotating disk has a plurality of engaging parts, and the brush plates are detachably connected to the engaging parts respectively.

In an embodiment of the invention, the brush disks are disposed on the rotating disk with equal angles.

In an embodiment of the invention, each of the brush disks has a plurality of bristles, disposed on a surface of each of the brush disks, and the bristles are extended perpendicularly to the surface.

The invention provides a wireless cleaning equipment that can guide the water flow during the cleaning process to avoid affecting the sight of user, and the wireless cleaning equipment has a function of rotation speed compensation to prevent the wireless cleaning equipment from driving the user to drift under the water.

The wireless cleaning equipment of the invention includes two clean brush heads, a first rod, two drive motors and a second rod. Wherein each of the two clean brush heads includes a rotating disk, a plurality of suction disks, and a plurality of brush disks. The rotating disk has a joint and a plurality of water inlets, the joint is located in the center of the rotating disk, and the plurality of water inlets surround the joint. The plurality of suction disks are disposed on a top surface of the rotating disk and each of the suction disks has a water outlet channel. The plurality of brush disks are disposed on a bottom surface of the rotating disk relative to the top surface and spaced apart from the joint. The water outlet channels of the suction disks are communicated with the water inlets, and the water outlet channels are extended in a direction away from the joint. The first rod rotatably sleeved around the two joints of the two cleaning brush heads. The two drive motors are respectively connected to the two joints of the two cleaning brush heads. The second rod connecting the two drive motors.

In an embodiment of the invention, the two driving motors are adapted to drive the two cleaning brush heads to rotate in opposite directions synchronously.

Based on the above, the cleaning brush head of the present invention is suitable for underwater cleaning work, and has a plurality of water inlets and a plurality of water outlet channels. When the cleaning brush head rotates, the water flow during the cleaning process will be guided along a radial direction to the cleaning brush head to prevent dirt in the water flow from blocking the user's sight.

The wireless cleaning equipment of the present invention combines two cleaning brush heads. During the cleaning process, the two cleaning brush heads rotate in opposite directions simultaneously, so that the rotational external forces of the two cleaning brush heads cancel each other out and avoid causing the user to be rotated and deflected under the water due to reaction force. Compared to the cleaning equipment with a single brush head, the user will be driven to rotate by a single brush head in the water. The wireless cleaning equipment of the present invention has no need to use additional fixing methods, so users could move freely under the water surface.

Several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic three-dimensional view of a cleaning brush head according to an embodiment of the present invention.

FIG. 2 is a schematic perspective view of the cleaning brush head of FIG. 1 from another angle.

FIG. 3 is a schematic three-dimensional view of a wireless cleaning equipment according to an embodiment of the present invention.

### DESCRIPTION OF THE EMBODIMENTS

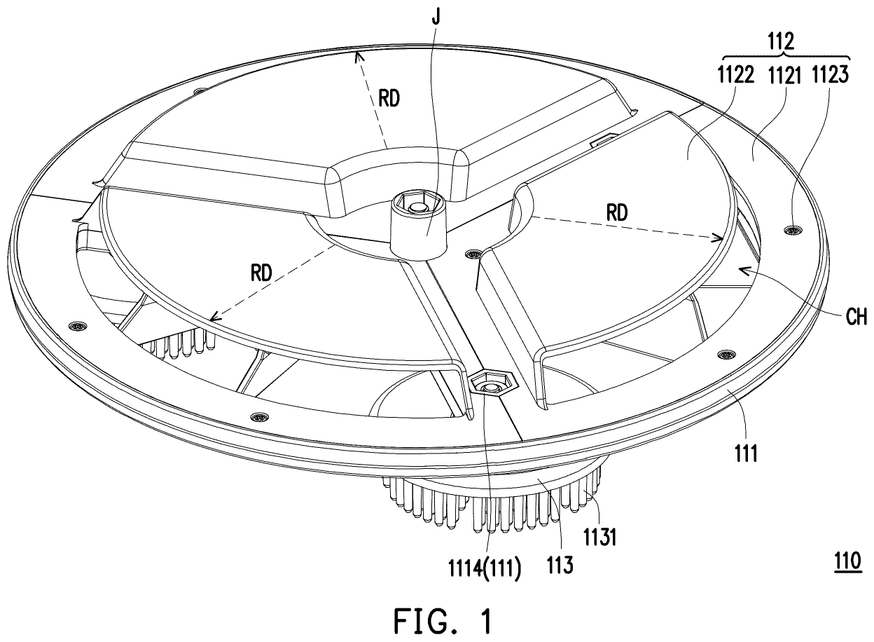

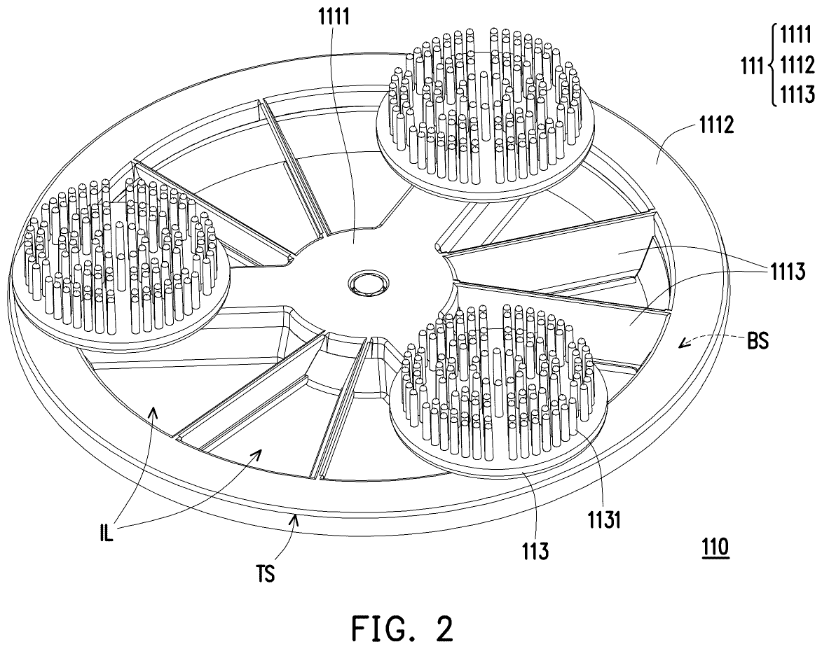

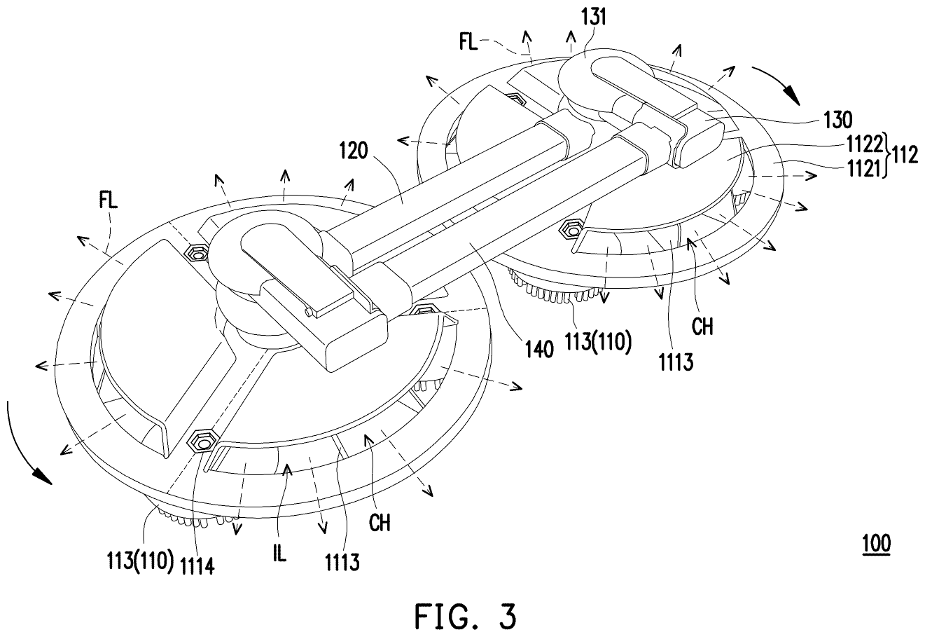

FIG. 1 is a schematic three-dimensional view of a cleaning brush head according to an embodiment of the present invention. FIG. 2 is a schematic perspective view of the cleaning brush head of FIG. 1 from another angle. FIG. 3 is a schematic three-dimensional view of a wireless cleaning equipment according to an embodiment of the present invention.

Referring to FIG. 3, the wireless cleaning equipment 100 of the present invention is suitable for underwater cleaning work and includes two cleaning brush heads 110, a first rod 120, two drive motors 130 and a second rod 140.

Referring to FIGS. 1 and 2, each cleaning brush head 110 includes a rotating disk 111, a plurality of suction disks 112 and a plurality of brush disks 113. The rotating disk 111 has a joint J and a plurality of water inlets IL. The joint J is located in the center of the rotating disk 111 and the plurality of water inlets IL surround the joint J. The plurality of suction disks 112 are disposed on a top surface TS of the rotating disk 111 and each of the suction disks 112 has a water outlet channel CH. The plurality of water outlet channels CH of the plurality of suction disks 112 are communicated with the plurality of water inlets IL, and the plurality of water outlet channels CH are extended in a direction away from the joint J.

The plurality of brush disks 113 are disposed on a bottom surface BS of the rotating disk 111 opposite to the top surface TS with equal angles and are spaced apart from the joint J. Further, each of the brush disks 113 has a plurality of bristles 1131 disposed on a surface of each brush disk 113, and the plurality of bristles 1131 are extended vertically on the surface. The plurality of brush disks 113 are suitable for using different forms of bristles according to requirement. Moreover, the plurality of water inlets IL are dislocated with the plurality of brush disks 113, so the water inlet volume of the cleaning brush head 110 can be increased to quickly clean the dirt on the hull surface, and a large water inlet volume can also ensure that foreign matter is not easily attached to the plurality of brush disks 113.

Referring to FIGS. 1 to 3, the first rod 120 is rotatably sleeved around the two joints J of the two cleaning brush heads 110. The two driving motors 130 are respectively connected to the two joints J of the two cleaning brush heads 110. In addition, the transmission shafts 131 of the two driving motors 130 are fastened to the joints J of the rotating disk 111. The two driving motors 130 are suitable for driving the two cleaning brush heads 110 to rotate in opposite directions synchronously to maintain the dynamic balance of the wireless cleaning equipment 100 under the water surface. In addition, the rotation speed of the two driving motors 130 can be adjusted, thereby adjusting the position of the wireless cleaning equipment 100 under the water surface.

The second rod 140 is connected to the two driving motors 130, thereby connecting the two driving motors 130 and the two cleaning brush heads 110 into a whole body. The first rod 120 and the second rod 140 can be held by the user and is used to absorb the vibration generated when the two driving motors 130 are operating.

Referring to FIGS. 1 and 2, the rotating disk 111 has a main body 1111, an outer ring 1112 and a plurality of blades 1113. The outer ring 1112 is connected to three outer edges of the main body 1111, and the plurality of blades 1113 are distributed between the main body 1111 and the outer ring 1112 to form the plurality of water inlets IL. Each of the suction disks 112 has a bottom plate 1121 and an upper cover 1122. The bottom plate 1121 is fixed on the main body 1111 and the outer ring 1112, and communicated with the water inlets IL. A plurality of screws 1123 are passed through each bottom plate 1121 and screwed to the main body 1111 and the outer ring 1112. The upper cover 1122 is disposed on the bottom plate 1121 and extended along a radial direction RD to form the water outlet channel CH.

The rotating disk 111 has a plurality of engaging portions 1114, and the plurality of brush disks 113 are respectively detachably connected to the plurality of engaging portions 1114. Specifically, each of the engaging portions 1114 is quick-release structure, and the brush disk 113 can be replaced manually without using tools.

Referring to FIGS. 1 to 3, when the wireless cleaning equipment 100 is operating, the transmission shafts 131 of the two drive motors 130 transmit power through the two joints J to drive the two rotating disks 111 to rotate in synchronous reverse directions, and at the same time, the plurality of blades 1113 rotates with the rotating disk 111. Due to the tilt angle of each blade 1113, during the rotation of the rotating disk 111, the water flow FL enters the rotating disk 111 along the plurality of water inlets IL, and then the water flow FL bumps into each blade 1113 and guided to the water outlet channel CH. The water flow FL will be discharged along the water outlet channel CH from the radial direction RD of the rotating disk 111 in the end, so it will not affect the user's sight. In addition, the plurality of water outlet channels CH of the plurality of suction disks 112 will discharge the water flow FL along the radial direction RD, so the water flow FL will continue to be distributed around the cleaning brush head 110, whereby the cleaning brush head 110 can avoid deflection under the water surface.

In other embodiments, the tilt angle of the blades can be adjusted according to needs, and the opening size of the water outlet channel CH can be adjusted according to the drainage volume.

Based on the above, the cleaning brush head of the present invention is suitable for underwater cleaning work, and has a plurality of water inlets and a plurality of water outlet channels. When the cleaning brush head rotates, the water flow during the cleaning process will be guided along a radial direction to the cleaning brush head to prevent dirt in the water flow from blocking the user's sight.

The wireless cleaning equipment of the present invention combines two cleaning brush heads. During the cleaning process, the two cleaning brush heads rotate in opposite directions simultaneously, so that the rotational external forces of the two cleaning brush heads cancel each other out and avoid causing the user to be rotated and deflected under the water due to reaction force. Compared to the cleaning equipment with a single brush head, the user will be driven to rotate by a single brush head in the water. The wireless cleaning equipment of the present invention has no need to use additional fixing methods, so users could move freely under the water surface.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A clean brush head, comprising:
a rotating disk having a joint and a plurality of water inlets, the joint located in the center of the rotating disk, and the plurality of water inlets surround the joint;
a plurality of suction disks disposed on a top surface of the rotating disk and each of the suction disks having a water outlet channel; and
a plurality of brush disks disposed on a bottom surface of the rotating disk relative to the top surface and spaced apart from the joint,
wherein, the water outlet channels of the suction disks are communicated with the water inlets, and the water outlet channels are extended in a direction away from the joint.

2. The clean brush head as recited in claim 1, wherein the rotating disk has a main body, an outer ring and a plurality of blades, the outer ring is connected to an outer edge of the main body, and the plurality of blades are distributed between the main body and the outer ring to form the water inlets.

3. The clean brush head as recited in claim 2, wherein each of the suction disks has a bottom plate and an upper cover, the bottom plate is fixed on the main body and the outer ring, and the bottom plate is communicated with the water inlets, the upper cover is disposed on the bottom plate and is extended along a radial direction to form the water outlet channel.

4. The clean brush head as recited in claim 3, further comprising a plurality of screws, passed through each of the bottom plates and screwed to the main body and the outer ring.

5. The clean brush head as recited in claim 1, wherein the rotating disk has a plurality of engaging parts, and the brush plates are detachably connected to the engaging parts respectively.

6. The clean brush head as recited in claim 5, wherein the brush disks are disposed on the rotating disk with equal angles.

7. The clean brush head as recited in claim 5, wherein each of the brush disks has a plurality of bristles, disposed on a surface of each of the brush disks, and the bristles are extended perpendicularly to the surface.

8. A wireless cleaning equipment, comprising:
two clean brush heads, wherein each of the two clean brush heads including:
a rotating disk having a joint and a plurality of water inlets, the joint located in the center of the rotating disk, and the plurality of water inlets surround the joint;
a plurality of suction disks disposed on a top surface of the rotating disk and each of the suction disks having a water outlet channel; and
a plurality of brush disks disposed on a bottom surface of the rotating disk relative to the top surface and spaced apart from the joint,
wherein, the water outlet channels of the suction disks are communicated with the water inlets, and the water outlet channels are extended in a direction away from the joint,
a first rod rotatably sleeved around the two joints of the two cleaning brush heads;
two drive motors are respectively connected to the two joints of the two cleaning brush heads; and
a second rod connecting the two drive motors.

9. The wireless cleaning equipment as recited in claim 8, wherein the two driving motors are adapted to drive the two cleaning brush heads to rotate in opposite directions synchronously.

10. The wireless cleaning equipment as recited in claim 8, wherein the rotating disk has a main body, an outer ring and a plurality of blades, the outer ring is connected to an outer edge of the main body, and the plurality of blades are distributed between the main body and the outer ring to form the water inlets.

11. The wireless cleaning equipment as recited in claim 10, wherein each of the suction disks has a bottom plate and an upper cover, the bottom plate is fixed on the main body and the outer ring, and the bottom plate is communicated with the water inlets, the upper cover is disposed on the bottom plate and is extended along a radial direction to form the water outlet channel.

12. The wireless cleaning equipment as recited in claim 11, further comprising a plurality of screws, passed through each of the bottom plates and screwed to the main body and the outer ring.

13. The wireless cleaning equipment as recited in claim 8, wherein the rotating disk has a plurality of engaging parts, and the brush plates are detachably connected to the engaging parts respectively.

14. The wireless cleaning equipment as recited in claim 8, wherein the brush disks are disposed on the rotating disk with equal angles.

15. The wireless cleaning equipment as recited in claim 8, wherein each of the brush disks has a plurality of bristles, disposed on a surface of each of the brush disks, and the bristles are extended perpendicularly to the surface.
